(19) United States
(12) Patent Application Publication
(10) Pub. No.: US 2014/0267047 A1
(43) Pub. Date: Sep. 18, 2014

(54) HANDLING INAPPROPRIATE INPUT METHOD USE

(71) Applicant: QUALCOMM INCORPORATED, San Diego, CA (US)

(72) Inventors: Michael William PADDON, Tokyo-to (JP); Matthew Christian DUGGAN, Tokyo (JP); Kento TARUI, Tokyo (JP)

(73) Assignee: QUALCOMM INCORPORATED, San Diego, CA (US)

(21) Appl. No.: 13/831,730

(22) Filed: Mar. 15, 2013

(51) Int. Cl. G06F 3/023

(52) U.S. Cl. CPC G06F 3/0233
USPC 345/168; 345/156

(57) ABSTRACT

Methods, systems and devices for handling an inappropriate input method used on a text input device receiving a user input entered with a first input method active in the form of a first set of discrete interactions with the device. The text input device may receive the first user input through the first input method and a second input method. At least one of the first and second input methods provides a conversion of the first user input to a symbol associated with a character set not shown on the text input device. A first orthographical incompatibility between the first user input and at least one of the first input method and the second input method may be determined. An indication may be output that an inappropriate input method was used based on the orthographical incompatibility.

### BACKGROUND

An “input method” is an operating system component or program that enables one or more user interactions with a text input device, coupled to a processor of the operating system, to be interpreted as representing a particular data element. Thus, the input method converts specific user interactions with the text input device (i.e., keyboard strokes, mouse movements, the activation of other input mechanisms or a combination or timing of such actions) into one or more text symbols. In this way, “input” from a user of a text input device is correlated to a particular set of discrete interactions by the user with the text input device and a particular input method. For example, the keystroke involved in typing on the keyboard of a computer or other electronic device employs a basic input method used by devices with keyboards to enter data corresponding to the symbols (such as an alpha-numeric character) found on the key that was pressed.

A language conversion input method is another example that goes further and provides a conversion of one or more user interactions into a symbol not found on the device's keyboard, such as a symbol from a character set not in the character set supported by the keyboard. When a user wishes to input characters from a language that uses a different character set from the native language of the device, a language conversion input method is generally used. Multilingual users often activate a language conversion input method when they use computers or mobile telephones that only have a Latin-character keyboard or numeric keypad, because they are unable to directly input Chinese, Japanese, Korean, or Indic character sets. The language conversion input method uses a predefined key, a combinations of keystrokes and/or other input available to the device to enable the user to enter data represented by one or more symbols otherwise unavailable to be entered as user input. The user often must select or activate the desired input method so that the device performs the conversion of the user interactions into the appropriate data. The activated (also referred to as “active”) input method is used by the text input device to generate text symbols that form the input.

A common mistake by users of such input methods occurs when users enter keystrokes using an inappropriate input method. An inappropriate input method refers to an input method not suitable or proper in the circumstances. For example, such as when a user mistakenly thinks one input method is inactive when a different input method is active. Another example includes when a Japanese-character input method is active on an input device, the user thinking that the Latin input method is active may type the English-language characters found on the keyboard, and only notice the mistake after entering many keystrokes. In such circumstances, all of the keystrokes entered using the wrong input method will be lost, requiring the user to delete the entered text symbols, switch to the proper input method, and retype the desired inputs.

Inappropriate use of an input method also commonly occurs to multi-lingual users when using applications that require frequent switching between input methods. For instance, when a program operating through the text input device requires text match a particular language but the active input method is not associated with that language, use of that active input is inappropriate. For example, when filling out a web page form, a Japanese user may need to fill in some fields in English characters (e.g. user-id, email address or telephone number) and other fields in Japanese (e.g. name, address, message). If the device has its default input method active, which converts keystrokes to English-language symbols found on the device keyboard, but the user types thinking his keystrokes are being converted to Japanese (i.e., the user thinks a Japanese input method is active), the result may look like unintelligible gibberish. Similarly, if a user is typing a Chinese document and switches to a web browser to type in a URL, the result may be nonsense instead of a web address unless the user remembers to switch input methods. Any multi-lingual environment in which the user is switching between applications, or fields within an application, is subject to this issue. This undesirable situation is especially prevalent on wireless devices which by necessity have small keyboards.

### SUMMARY

The various embodiments include a method of handling an inappropriate input method by a user on a text input device configured to convert discrete interactions by the user into text symbols through an active input method selected from at least two input methods. At least one of the at least two input methods provides a conversion of the discrete interactions to a symbol associated with a character set not shown on the text input device. The method may include receiving a first input comprising a first set of discrete interactions by the user on the text input device as processed with a first input method active. Also, the method may determine whether there is a first orthographic incompatibility between the first input and at least one of the first input method and a second input method. An indication may be output that the first input method is inappropriate as the active input method in response to the text input device recognizing that the first input includes a first orthographic incompatibility with one of the input methods.

Further embodiments may include a computing device having a processor configured with processor-executable instructions to perform various operations corresponding to the methods discussed above.

Further embodiments may include a computing device having various means for performing functions corresponding to the method operations discussed above.

Further embodiments may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is an illustration of a conventional mobile communication device showing a user entering English-language text with no input method active.

FIG. 2 is an illustration of a conventional mobile communication device showing a user entering Japanese kana characters

FIG. 3 illustrates an example user interface on a mobile device in the event of detected input method error suitable for use with the various embodiments.

FIG. 4 is a process flow diagram illustrating an embodiment method for handling an inappropriate input method.

FIG. 5 is an illustration of a mobile device showing a user selecting text representing an alternative input method according to the various embodiments.

FIG. 6 is an illustration of a mobile device showing replacement text corresponding to an alternative input method according to the various embodiments.

FIG. 7 is a process flow diagram illustrating an embodiment method for determining an orthographical incompatibility.

FIG. 8 is a process flow diagram illustrating an embodiment method for determining potential alternative input method(s).

FIG. 9 is a component diagram of a computing device suitable for use with the various embodiments.

FIG. 10 is a component diagram of another computing device suitable for use with the various embodiments.

FIG. 11 is a component diagram of another computing device suitable for use with the various embodiments.

### DETAILED DESCRIPTION

Aspects disclosed herein relate to handling the use of an inappropriate input method. In particular, by detecting when a user has likely used the wrong input method, and providing a way to recover from the error, a user experience may be improved. The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein the term “orthographical incompatibility” refers to an inconsistent or unusable combination of letters or symbols for an input method and/or a language or character set corresponding to the input method. In this respect, an orthographical incompatibility represents more than a spelling error or unrecognized word, and reflects a particular combination of symbols that are gibberish in the language corresponding to the input method. Also, the term “gibberish” refers to unintelligible or meaningless words or combinations of symbols.

Handling the use of an inappropriate input method has particular application when one or more language conversion input methods are involved. Another example of a language conversion input method is the pinyin input method. The pinyin input method actually refers to a family of input methods based on a method of Romanization of Chinese characters. In the most basic form, the pinyin method allows a user to input Chinese characters by entering the “pinyin” (which literally means “spelled-out sounds”) of a Chinese character. This system is used to transcribe or convert Chinese characters into Latin script and may be used as an input method to enter Chinese characters ( [symbol] , hànzì) into computers and other electronic devices limited to only a standard QWERTY keyboard (i.e., a keyboard limited to the 26 Latin letters, 10 Arabic numerals and punctuation marks). For example, in order to enter “ [symbol] [symbol] ” (zhonghuárénmíngònghéguó) into a computer using a conventional QWERTY keyboard, a user may type “zhonghuarenmingongheguo” using a Full Pinyin input method, which converts these discrete keyboard interactions by an algorithm to output “ [symbol] ”. Alternatively, using the Double Pinyin input method, the user may type “vshwrfmngshego” (v=zh, s=ong, h=h, w=ua, r=r, f=en, m=m, n=in, g=g, s=ong, h=h, e=e, g=g, o=uo), which involves a shorthand that offers the user a faster method than the Full Pinyin input method, but still generates the same or similar output. In both these examples of language conversion input methods, the discrete interactions (i.e., individual keystrokes) on the QWERTY keyboard are considered discrete interactions with the computer. Thus, an advantage of the Double Pinyin input method is that it requires fewer discrete interactions with the computer keyboard.

FIGS. 1 and 2 show an example of what happens with contemporary systems of the prior art between using the correct input method and an inappropriate input method. FIG. 1 illustrates a wireless mobile communication device 10 with a display 12 and a keyboard 14. A user's finger 5 is shown in phantom about to interact with the text input device by engaging a key on the keyboard 14. In this example, the device 10 has a default basic input method active, which means the key typed by the user directly reflects the symbol (character) generated on the display 12 as text 15. Thus, by pressing a key corresponding to a symbol shown on the device, the code for that symbol will be entered in the device and the corresponding symbol shown on the display 12 as part of text 15. In this illustrative example, the user has already entered at least the greeting, “Hello Taro,” as well as the body, “We start the meeting regarding the Green account at 11 AM”. In this circumstance an appropriate input method was used, since the entered text 15 makes sense and does not contain gibberish.

FIG. 2 illustrates the same wireless mobile communication device 10 in an alternative scenario with a different input method active. In particular, FIG. 2 shows a Japanese direct kana input method active. However, FIG. 2 is an example of an inappropriate input method being used because the user entered the same keystrokes entered for the example of FIG. 1, which do not correspond to a Japanese direct kanainput method. With the direct kanainput method active, the same keystrokes are converted into Japanese Kana characters. As a result, in contrast to FIG. 1, the Japanese character symbols in this scenario do not form actual words in Japanese, and may thus be considered gibberish. Thus, the scenario of FIG. 2 shows an example of an inappropriate input method being used.

For entering Japanese, a common input method involves entering romanized (transliterated) kana directly, since Japanese Kana characters can be matched on a one-to-one basis with QWERTY keyboard characters. A further conversion would be needed to change such kana characters to Kanji, which is a more formal form of Japanese writing. So using a Japanese direct kana input method, a user who wishes to type [symbol] , (which transliterated sounds like “Takahashi”, a Japanese name), could type “q t f d.” The direct kana input method has one keystroke assigned to each sound. Another common Japanese input method is referred to as “phonetic” kana, whereby a user may simply type “takahashi” and a system algorithm converts it to [symbol] . Each of these input methods may be considered a different input method even though they relate to the same language. Other languages like Chinese similarly have multiple input methods, such as Pinyin and Wubi, that relate to the language. With the basic input method used for FIG. 1 active this same set of discrete interactions with the keyboard (i.e., pressing each of those keys) would simply translate into the Latin letters “q”, “t”, “f” and “d.” However, with the Japanese direct kana input method active, those four keystrokes generate [symbol] , which is presumably what the user wanted. In other words, the characters “q”, “t”, “f” and “d” typed on the keyboard result in the input of “ [symbol] ”, “ [symbol] ”, “ [symbol] ” and “ [symbol] ”, respectively, when using the Japanese direct kana input method.

FIG. 3 illustrates an embodiment in which a user can more easily recover from the use of an inappropriate input method. The scenario shown in FIG. 3 corresponds to that noted above where the user input is entered using a first input method (the basic input method), but that input method is inappropriate because a second input method (the Japanese direct kana input method) should have been active. As indicated in the example above, the user may have pressed the “q”, “t”, “f” and “d” keys thinking it would enter “ [symbol] [symbol] ”, but instead simply “qtfd” is the text 15″ shown in the display 12 because the basic input method was active. Each of those keystrokes is a discrete interaction with the text input device (one discrete interaction for each key pressed). In this scenario the user input is received with the basic input method active and a second input method is available, namely the Japanese Direct kana input method. Thus, the text input device 10 is adapted to receive user inputs through a first and second input method, although the device may be adapted to receive user input through more than two input methods. At least one of the input methods (namely the second input method in this scenario) provides a conversion of the user inputs into symbols associated with a character set not shown on the text input device. In this case the symbols associated with a character set not shown on the text input device are the Japanese Kana characters.

The embodiment methods determine whether a first orthographical incompatibility exists between the user input and one of the input methods. As discussed in more detail below, there are various ways to recognize an orthographical incompatibility, but once an orthographical incompatibility is recognized, an indication that the input method used is inappropriate may be output by the device. In the illustrated example, that indication is in the form of the on-screen message 20 “INPUT METHOD ERROR.” This visual indicator that an inappropriate input method was used may also includes the text “Alternative(s)” along with a suggested substitute 22, namely characters that would be generated using the second input method based on the same inputs. Thus, a “visual indicator” may be a visible display of information related to a detected orthographical incompatibility. Alternatively or additionally, the device may make an audible sound, the screen may flash, or the device may provide the indication of the error in some other way that communicates to the user. Also, rather than providing the user with one or more text alternatives from which to select, the text input device may provide an auto-correct function that automatically makes the conversion and switches to the correct input method under certain circumstances.

FIG. 4 illustrates an embodiment method 100 for handling an inappropriate input method used on a text input device. This method may be performed on the text input device or a separate device operatively coupled to the text input device. In block 110, a user input entered into a text input device is received. The user inputs are processed by an input method activated on the text input device, which may be considered a first input method. As described above, the user input results from the user performing a set of discrete interactions with the text input device, such as individual keystrokes. As used herein, the expression “set of discrete interaction” refers to a series of separate actions performed by the user to input data into the text input device. While two or more of those discrete interactions may be the same action repeated, each discrete interaction is processed separately and may be distinguishable from each other in some way. The discrete interactions may be entered into the text input device in various ways, such as a mouse movement, a finger swipe, a keystroke, and/or a hold-time of a keystroke. Additionally, individual discrete interactions may be interpreted differently based upon a delay-time between individual interactions. The defining parameters or interpretations of discrete interactions may be dictated by the processor component receiving the input method or the input method itself.

In the various embodiments, the text input device is configured to receive the user input through at least two input methods, in which at least one of those two input methods converts the user input to symbols associated with a character set that is not shown on the text input device. In block 120 an orthographical incompatibility check of the user input is initiated, either automatically or manually. Alternatively, the user or a system/program working on or in conjunction with the device may separately initiate the check. For example, if another program into which the user input is being entered requires a certain input method, the orthographical incompatibility check may be initiated by that program. Once the orthographical incompatibility check is initiated, in block 130 information identifying the set of discrete interactions associated with the user input may be stored in a memory. The memory may be in the text input device or in another separate computing device. The system may retain a buffer of all keystrokes or other discrete interactions entered into the text input device. In block 140, a test for orthographical incompatibility between the received user input and one or more of the input methods is performed. Methods for recognizing orthographical incompatibility are further discussed below with reference to FIG. 7 and embodiment method 200. Alternatively, the individual discrete interactions (or information characterizing those interactions) may be stored in memory in block 130 before the orthographical incompatibility check is initiated in block 120, or after an orthographical incompatibility has been identified in block 140.

Once a determination has been made that the user input is orthographically incompatible with either the input method used to enter that input or at least one other input method, in block 150 an indication of this conclusion may be output. This indication may take many forms. An indication may include a simple audible tone, a vibration, or a visual signal from the text input device. The visual signal may include a flashing dedicated LED, a blinking portion of a screen display of the text input device, or other change of the display. A more complex indication may include a combination of these indications and/or a more complex audio or visual output. The indication that the user input is inappropriate in the form of a visual indicator on the text input device in block 150 may include a portion of a screen display that shows one or more alternative input methods, as a suggested alternative. In block 160 a determination may be made of potential alternative input methods better suited to the individual discrete interactions. Thus, if potential alternative input methods are part of the output indication in block 150, then the determination in block 160 may be performed prior to or together with the output indication in block 150.

The determination of potential alternative input methods in block 160 may be accomplished in various ways depending upon the number of input method implemented on the text input device. If only one alternative is available on the text input device, this determination is rather simple. However, if more than one alternative input method is available, then either all possible alternatives may be presented to a user or the potential alternatives may be limited in some way. An embodiment method of determining one or more potential alternative input methods is discussed in more detail below with reference to FIG. 8 and the embodiment method 300. As part of thin determination of potential alternative input methods, a second (further) orthographical incompatibility may be determined between the user input and any one of those potential alternative input methods considered by the method 300. In an embodiment, any alternative input method associated with a further orthographical incompatibility may be excluded from the options presented to the user for alternative input methods (i.e., it is not included on a presented list of alternatives). Thus, additional alternative input methods may be ruled out in this way or remain viable candidates after the screening of method 300. Further, the potential alternatives may be presented in a hierarchy or order of estimated “best fit.” Such a best fit may be based on how orthographically compatible the alternative input method is, how orthographically incompatible the alternative input method is, or based on a heuristic approach. A heuristic approach may take into account a user profile and/or historical record of user activity (i.e., prior usage of an input method by a user or on the device). For example, input methods associated with a user profile, the most recently used input methods, or the input methods whose failure to use most frequently causes an orthographical incompatibility may be weighted more heavily. If only one alternative input method has ever been used by the user, this may be a particularly helpful factor.

The display of a potential alternative input method (including those incorporated into part of the output indication of block 150 or performed separately) may indicate a name for the alternative input method or just show the text output resulting from using that alternative input method. FIG. 3 shows a potential alternative input method 22, displayed as a conversion of the user input using that alternative input method. While FIG. 3 includes only one listed alternative, additional determined alternatives may be displayed. In this manner, the user may select the alternative input method, or an input method from a list of presented choices if more than one is presented, in order to easily recover from the error.

In a further embodiment, a determination may be made in block 170 of the method 100 regarding the appropriate replacement input method. This determination may be made as a result of receiving further user inputs identifying a user selected alternative input method. For example, the user may have identified the appropriate input method on her own, selected it from presented alternatives (as discussed above), or indicated acceptance of a single presented alternative input method (as shown in FIG. 5) by making a further user input, such as a key touch or mouse click action. User inputs may also be received via a microphone and a speech to text translation function, tactile interactions, or other dedicated input mechanism. For example, a spoken command may identify an alternative input method or agree with utilizing the best alternative identified by the text input device. A dedicated input action, such as a predetermined gesture or a dedicated button, may similarly identify an alternative input method or agree with utilizing the best alternative identified by the text input device.

In block 180 a converted text may be generated using the replacement input method determined in block 170. Thus, when a replacement input method is acknowledged or determined, the selected input method may be used to generate a converted text, replacing the text originally generated from the user input using the first input method. The replacement text may be generated as a first order converted text or a second order converted text. A first order converted text reconsiders the subject set of discrete interactions (i.e., the exact same keystrokes) as if they were made using the replacement input method. For example, this may be performed by accessing the individual discrete interactions stored in the memory buffer in block 130. The result of this conversion may be output in block 190 as converted text 25, shown in FIG. 6, which is a first order converted text.

This completed process is an example of an input method recovery technique. When a first order converted text corrects the inappropriate input method use, the user 6 may proceed with further individual discrete interactions with the keyboard, which are converted using the appropriate input method. A first order converted text input may be helpful when the user has entered the appropriate set of discrete interactions, but simply failed to have the appropriate input method active.

However, in situations in which the user enters a set of discrete interactions that are inappropriate for an input method or for the circumstance, a first order converted text may not be enough; a second order conversion may be needed. For example, when a basic input method that uses the English language is active and a program running on the text input device requires Latin-based characters (a conventional QWERTY keyboard), but the user enters text thinking a different input method is active (e.g., a input method for Indic characters), a playback of the discrete interactions from memory for processing by an Indic Input method active may generate inappropriate text (because the program requires Latin-based characters). In such a circumstance, a second order conversion that uses a language translation of the first order converted text, may be used in order to generate an acceptable text while saving the user from performing a new set of discrete interactions. This process of generating a second order converted text is another example of an input method recovery technique.

Another form of visual indicator, as part of the output indication in block 150, may take the form of an automatic conversion of the user input applying a second input method. Such an automatic conversion may take place in response to a further user input acknowledging/accepting the determination of orthographical incompatibility. Alternatively, such an automatic conversion may accomplished without the user having to first acknowledge the error in applying the wrong input method. This type of automatic recovery conversion may be reserved for circumstance in which the text input device determines that the input method was inappropriate and that the correct input method may be determined with a particular level of statistical certainty. Thus, there may be two factors to consider before performing an automatic conversion; one factor being how likely it is that an orthographical incompatibility exists, and the second factor being how likely the correct alternative input method has been determined. An embodiment with these automatic determinations may allow adjustment or selection of the level of statistical likelihood for one or both of these factors. Also, such an automatic conversion may be reserved for only certain input methods. Thus, the determinations in blocks 140, 160 and 170, the generation of converted text in block 180, and output of the converted text in block 190 may be performed together or immediately in sequence in order to generate the output indication in block 150. An automatic conversion like this may be further accompanied by an audible tone, vibration or additional visual indicator (like underlining or highlighting the replaced text) in order to make the user aware of what has happened.

The system may support input method recovery mechanisms specific to a particular the text input device language. For instance, it may offer an option to recover only numerical keystrokes so that Chinese numerals are converted to Arabic numerals. Another example would be an option to recover all discrete interactions (such as keystrokes) so that a language like Japanese is converted to full-width text (possibly ignoring existing full-with characters). A further example relates to when a language supports different representations of the same character. For instance, Japanese input methods support “half width” and “full width” modes, and a user is often required to select the correct width in order for the application to accept the input as valid.

In an embodiment, the automatic detection of an orthographical incompatibility between the user input and one or more input methods may be handled in various ways. On a basic level, such an orthographical incompatibility may be determined between the user input and at least one of two input methods implemented on the text input device. So on the one hand, the recognized orthographic incompatibility may be between the user input and the very same input method active when the user input was entered. On the other hand, the recognized orthographic incompatibility may be between the user input and an input method other than that input method active when the user input was entered. Additionally, for either of those input methods the orthographic incompatibility may be determined from an aspect of the input method itself and/or an aspect of the underlying language associated with the input method in question.

FIG. 7 illustrates an embodiment method 200 for determining whether there is an orthographical incompatibility associated with a particular user input and the input method used to enter that user input. Following the start of the orthographical incompatibility check in block 210, an initial determination may be made in block 220 regarding whether the active input method (i.e., the particular input method used) matches a known appropriate input method. For example, although a first input method was used to enter the user input, a program operating on the text input device for which the user input was entered may require a second input method. In this situation that second input method is the appropriate known input method. Alternatively, the user may provide supplemental user input that identifies the appropriate input method, making that identified input method the “known” input method for purposes of an orthographical incompatibility check. Thus, in block 220 the active input method (“Active”) is compared to a known input method (“Known”). If the known the input method is not equal to the active input method, then an orthographical incompatibility indication may be output in block 250. In this way, an indication of an orthographical incompatibility may be output in block 250 because the set of discrete interaction were entered using a first input method, when a second input method was required. This may be the case when the set of discrete interactions matches the required second input method, but since the individual discrete interactions were entered using the first input method an orthographical incompatibility may exist. In contrast, if the Active input method is the known input method or if there is simply no known input method, then the orthographical incompatibility check may continue to block 230.

In block 230 of the method 200 the user input may be analyzed for fourth orthographic compatibility (or the lack thereof) with the target input method. For example, if the user tries to type “mistake” when a phonetic Japanese input method is active, the two discrete interactions corresponding to typing the “s” key followed by the “t” key (i.e., “st”) may be immediately recognized as an orthographically incompatibility with the active input method itself, since this combination is not recognized for that input method (i.e., it is an impossible combination never used for that input method). In contrast, using a direct Japanese input method, typing “st” may be converted by a system algorithm to “ [symbol] ”, which is not incompatible with that input method. This contrast illustrates how two discrete interactions may be compatible with one input method, yet incompatible with at least one other.

If the user input is determined to be orthographically incompatible with the active input method then an orthographical incompatibility indication may be output in block 250. The analysis for orthographic compatibility (or incompatibility) with the target input method may include determining whether a set of discrete interactions entered with a particular input method active matches a predefined set of discrete interactions convertible by the active input method into a symbol.

As part of the determination in block 230, so-called “false positives” may be taken into consideration. False positives may include one or more sets of discrete interactions or patterns of interaction that, while not intended to form words generally associated with the active input method, are nonetheless acceptable for that input method. In this way, one or more predefined sets of discrete interactions with the text input device, not generally associated with the first input method, may be excluded from the determination of an orthographic incompatibility. For example, phone numbers or email addresses are usually entered in predictable patterns, which may be excluded from being considered orthographically incompatible with the active input method.

If the user input is not orthographically incompatible with the active input method then the orthographical incompatibility check may continue to block 240. Alternatively, even if the first stage comparison of the user input for an orthographical incompatibility in block 230 is positive, such a result may be stored and the process may perform the second stage comparison in block 240 in order to calculate a probability that an actual orthographical incompatibility has occurred. For example, in such an alternative an indication of an orthographical incompatibility may be output in block 250 only if both determinations in blocks 230 and 240 are positive.

In block 240 of the method 200 the user input may be analyzed for orthographically compatibility with the language associated with the active input method. In this regard, even the basic input method is associated with a “native” language of the text input device. Such a native language is the primary language the manufacturer, reseller or other entity intended to be used with that device. In this regard, a language incompatibility may mean the user input forms gibberish in the language associated with the active input method. For example, a word list may be used to determine whether the user input is a proper word for the active input method. For instance, if the user types “chonbo” when an English input method is active, the system may recognize that “chonbo” is not an English language word (such a by comparing the input to a dictionary) and infer that an error in input method selection has occurred.

If the user input is determined to be orthographically incompatible with the active input method language, then an orthographical incompatibility indication may be output in block 250. However, like the determination made in block 230, this analysis may be prone to false positives. For example, the determination in block 240 may be made in much the same way as a spell check program used in contemporary word processors, but it may not be helpful to identify minor typographical errors as an orthographical incompatibility. Thus, before proceeding to block 250 from the analysis of block 240 an error probability may be calculated as discussed in more detail below. For example, one way to ensure the orthographical incompatibility is not a minor typographical error (consistent with the error probability determination) is to further perform the orthographical incompatibility check considering the user input as if entered using a second input method. Such a second input method may be predicted based on heuristics or more than one other input method may be checked in this way. If checking any one of the second or other input methods in this way does not generate an orthographical incompatibility indication, this may confirm the initial orthographical incompatibility determination in block 240 was likely not just a typographical error, and thus the process may safely proceed to block 250. Otherwise, if the user input is not orthographically incompatible with the active input method language then the orthographical incompatibility check may end in block 260. Similarly, once an orthographical incompatibility is indicated as an output in block 250, the process may end the orthographical incompatibility check in block 260.

Additionally, when making the determination regarding whether an orthographical incompatibility has been made, consideration may be given to the fact that some scripts can exhibit this problem within a single field. For instance, in Japanese it is common to mix characters from several input modes in a single sentence.

FIG. 8 illustrates an embodiment method 300 for determining potential alternative input methods when an orthographical incompatibility has been identified. The various aspects of the method 300 may be used in part or as a whole to identify one or more potential alternative input methods that might be compatible, based on the circumstances. As shown, once the process of determining potential alternative input method(s) is initiated in block 310, in determination block 320 the device may determine whether an appropriate input method is known. This is a similar inquiry to that discussed above with reference to FIG. 7 and block 220 of method 200. If the appropriate input method is known, it may be output as an alternative input method in block 325. The output may result in a display on a screen of the text input device, such as that shown in FIGS. 3 and 4. Also, if the input method is known, such as because it is required by a program or application for which the user input is intended, then the output in block 325 may coincide with the termination of the method 300. Alternatively, the process may continue in block 330. Similarly, if an appropriate input method is not known in determination block 320, the process may begin analyzing input methods by setting the active input method (the one used to enter the user input) as a “target” input method in block 330. The method 300 may continue in block 330 by analyzing a different input method first, if desired. Nonetheless, if the active input method is set as the target in block 330 then in determination block 335 the device checks whether that active input method was previously found to be orthographically incompatible (such as in blocks 220, 230 or 240 of method 200).

If an orthographic incompatibility check was previously performed (i.e., determination block 335=“Yes”), a “next potential alternative” input method may be set as the target for further analysis in block 340. Thereafter, or if an orthographic incompatibility check was not previously performed on the active input method or the results not saved (i.e., determination block 335=“No”), a first stage analysis of a target input method may performed in determination block 350. When determination block 350 is performed immediately after determination block 335, it would be the active input method analyzed, and when determination block 350 is performed immediately after block 340 it would be the next potential alternative input method analyzed.

The analysis in determination block 350 determines whether the user input is incompatible with the target input method itself. This analysis is similar to what is described above with respect to determination block 230 of method 200, including the ruling out of false-positives. It should be noted that the active input method may be analyzed in block 350 because a two-stage input method analysis may have been circumvented in determination block 220, if the active input method was not the same as the known input method. If there is no incompatibility found (i.e., determination block 350=“No”), the second stage analysis of the target input method may be addressed in determination block 370, which is a similar analysis to what was described above with respect to determination block 240. If both of these two stages of analysis, represented by determination block 350 and determination block 370, find no orthographic incompatibility, in block 380 the target input method may be added to a potential alternative input method list. In contrast, if either of the two stages of analysis, represented by determination block 350 and determination block 370, find an orthographic incompatibility, then the target input method will not be considered as a potential alternative. However, as an alternative, if the first stage analysis in determination block 350 determines that there is an orthographic incompatibility between the input and target input method (i.e., determination block 350=“Yes”), the result may be stored and the analysis in determination block 370 may be made in order to determine an error probability that the target user input is truly incompatible (similar to the alternative discussed above with reference to FIG. 7 and blocks 230, 240 of method 200).

As discussed above, either of the first or second stages of analysis may have an override for a particular alternative input method designated to be included on a final potential alternative input method list. For example, if through heuristics it is determined that a particular alternative input method is very likely to be the desired alternative, the two stage check may be circumvented and that input method added in block 380.

Whether the target input method was added to the list or not, in determination block 360 a determination may be made regarding whether there are additional input methods available as potential alternatives. If there are may alternatives available (a hierarchy or order may be established in order to decide which one should be analyzed next. Once again, heuristics may be employed in order to determine which input method to analyze next. Once the next alternative is designated for analysis, it is then set as the target input method in block 340 and the process continues again as above. This cycle may continue until all potential alternatives are identified or in determination block 360 a limit may be kept for how many alternatives may be added to the list. Once there are no further alternatives or that limit has been reached, the process may conclude in block 390 with an output of a list of the potential alternative input methods determined.

As disclosed herein the various embodiment determinations and processes, such as whether there exists an orthographical incompatibility, which potential alternative input methods might apply, which replacement input method should be applied, whether various processes should occur automatically and other process aspects disclosed herein, may be made using an error probability. In this way, a probability that an error has occurred (or the probability that no error has not occurred) may be calculated. Such a calculation may be used to require a particular level of certainty before reaching a conclusion on a determination or moving to a next step. For example, an error probability may be determined based on the orthographical incompatibility determination. In this way, the indication that the first input method is inappropriate may only be output in response to such an error probability exceeding a predefined threshold. What is more, such a predefined threshold may be a value set by a program used to make thin determination or it may be adjustable by the user or others. Considerations, such as whether both orthographic nonsense and nonsense words have occurred, may be used to infer a higher probability that an error in the use of a particular input method has occurred. A threshold may be set by the system (or by the user) to determine how sensitive the detection mechanism is.

The various embodiments may be implemented in and/or with any of a variety of computing devices, such as a mobile telephone, a further example of which is illustrated in FIG. 9 in the form of a partial section view of a cellular telephone. Typical mobile computing devices 900 will have in common the components illustrated in FIG. 9. For example, mobile computing devices 900 may include a processor 901 coupled to an internal memory 902 and a touch surface input device/display 903, such as a resistive sensing touch-screen 904, capacitive sensing touch-screen, infrared sensing touch-screen, acoustic/piezoelectric sensing touch-screen, or the like. The mobile computing device 900 may have a radio/antenna 906 for sending and receiving electromagnetic radiation that is connected to a wireless data link and/or cellular telephone transceiver 920 coupled to the processor 901. Mobile computing devices 900 may also include a GPS receiver coupled to the processor 901 for determining locations of the device. Mobile computing devices 900 may also include physical buttons 908 for receiving user inputs.

The various embodiments may be implemented in and/or with any of a variety of computing devices, such as a tablet computer, an example of which is illustrated in FIG. 10. For example, the wireless device 1000 may include a processor 1002 coupled to internal memories 1004 and 1006. Internal memories 1004 and 1006 may be volatile or non-volatile memories, and may also be secure and/or encrypted memories, or unsecure and/or unencrypted memories, or any combination thereof. The processor 1002 may also be coupled to a user interface, such as a touch screen display 1016 (e.g., a resistive-sensing touch screen, capacitive-sensing touch screen infrared sensing touch screen, or the like), or conventional buttons (e.g., 1012a and 1012b) and a non-touch screen display. Additionally, the wireless device 1000 may include one or more network transceivers configured to enable the processor 1002 to communicate with other computing devices over one or more wired or wireless networks. As a particular example, the network transceivers of a wireless device 1000 may include one or more antenna 1018 for sending and receiving electromagnetic radiation that may be connected to one or more wireless data link transceiver and/or cellular telephone transceiver 1010 coupled to the processor 1002. The wireless device 1000 may also include physical buttons 1012a and 1012b for receiving user inputs.

The various embodiments described above may also be implemented within and/or with a variety of personal computing devices, such as a laptop computer 1100 as illustrated in FIG. 11. Many laptop computers include a touch pad touch surface 1107 that serves as the computer's pointing device, and thus may receive drag, scroll, and flick gestures similar to those implemented on mobile computing devices equipped with a touch screen display and described above. A laptop computer 1100 will typically include a processor 1101 coupled to volatile memory and a large capacity nonvolatile memory, such as a flash memory device 1102. The laptop computer 1100 may also include a floppy disc drive and a compact disc (CD) drive coupled to the processor 1101. The laptop computer 1100 may also include a number of network transceivers or network connector ports 1106 coupled to the processor 1101 configured to enable the processor 1102 to communicate with other computing devices one or more wired or wireless networks. As a particular example, the network transceivers of a laptop computer 1100 may include Ethernet, USB or FireWire® connector sockets/transceivers, one or more wireless modem transceivers, such as Wi-Fi and/or cellular data network transceivers, coupled to one or more antenna for sending and receiving electromagnetic radiation. The laptop computer 1100 may also include other types of network connection circuits for coupling the processor 1101 to a network that may be developed in the future. In a notebook configuration, the computer housing 1105 includes the touchpad 1107, the keyboard 1108, and the display 1109 all coupled to the processor 1101. Other configurations of the computing device may include a computer mouse or trackball coupled to the processor (e.g., via a USB input) as are well known, which may also be used in conjunction with the various embodiments.

The various embodiments may also be implemented in and/or with any of a variety of commercially available server devices. Such a server typically includes a processor coupled to volatile memory and a large capacity nonvolatile memory, such as a disk drive. The server may also include a floppy disc drive, compact disc (CD) or DVD disc drive coupled to the processor. The server may also include network access ports coupled to the processor for establishing network interface connections with a network, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

The processors in the various embodiments described herein may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices the internal memory may be a volatile or nonvolatile memory, such as flash memory, or a mixture of both. For the purposes of this description, a general reference to memory refers to memory accessible by the processors including internal memory or removable memory plugged into the device and memory within the processor themselves.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order.

Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular. The word “exemplary” is used herein to mean “serving as an example, instance, or illustration.” Any implementation described herein as “exemplary” is not necessarily to be construed as preferred or advantageous over other implementations.

The various illustrative logical blocks, modules, circuits, and process flow diagram blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of handling an inappropriate use by a user of a first input method on a text input device adapted to convert discrete interactions by the user with the text input device to text symbols through an active input method selected from the first input method and a second input method, wherein at least one of the first input method and second input method provides a conversion of a first set of discrete interactions to a symbol associated with a character set not shown on the text input device, the method comprising:
receiving a first input comprising the first set of discrete interactions by the user on the text input device as processed with the first input method active;
determining whether there is a first orthographic incompatibility between the first input and at least one of the first input method and the second input method; and
outputting an indication that the first input method is inappropriate as the active input method in response to the first input including the first orthographic incompatibility.

2. The method of claim 1, wherein determining whether there is the first orthographic incompatibility between the first input and at least one of the first input method and the second input method comprises determining whether the first set of discrete interactions match a first predefined set of discrete interactions convertible by the first input method into a first symbol.

3. The method of claim 2, wherein determining whether there is the first orthographic incompatibility between the first input and at least one of the first input method and the second input method further comprises determining whether the first set of discrete interactions match a second predefined set of discrete interactions convertible by the second input method into a second symbol.

4. The method of claim 3, wherein the second input method is selected based on a prior usage of the second input method in association with the text input device.

5. The method of claim 1, wherein determining whether there is the first orthographic incompatibility between the first input and at least one of the first input method and the second input method comprises determining whether a first entered text formed from the first user input includes a word not associated with the first input method.

6. The method of claim 1, wherein individual interactions of the first set of discrete interactions are entered into the text input device by way of at least one of a mouse movement, a finger swipe, a keystroke, a hold-time of the keystroke and a delay-time between the individual interactions.

7. The method of claim 1, further comprising:
determining an error probability that the first user input includes the first orthographic incompatibility,
wherein outputting the indication that the first input method is inappropriate as the active input method occurs in response to the error probability exceeding a predefined threshold.

8. The method of claim 7, wherein the predefined threshold is adjustable based on a second input to the text input device.

9. The method of claim 7, wherein outputting the indication that the first input method is inappropriate as the active input method comprises converting the first set of discrete interactions to second entered text applying the second input method in response to the error probability exceeding the predefined threshold.

10. The method of claim 1, wherein determining whether there is the first orthographic incompatibility between the first input and at least one of the first input method and the second input method excludes a predefined set of discrete interactions from determining the first input includes the first orthographic incompatibility.

11. The method of claim 1, wherein determining whether there is the first orthographic incompatibility between the first input and at least one of the first input method and the second input method comprises determining whether the first set of discrete interactions match a second predefined set of discrete interactions convertible by the second input method into a second symbol in response to a program operating through the text input device requiring entered text match a language associated with the second input method.

12. The method of claim 1, wherein outputting the indication that the first input method is inappropriate as the active input method includes at least one of an audible sound, a vibration and a visible signal reflecting the indication that the first input method is inappropriate as the active input method.

13. The method of claim 1, wherein outputting the indication that the first input method is inappropriate as the active input method includes a first visual indicator on the text input device representing the second input method as a suggested first alternative.

14. The method of claim 13, further comprising:
determining whether there is a second orthographical incompatibility between the first input and a third input method different from the first input method and the second input method, the third input method being excluded from the first visual indicator as a further suggested alternative.

15. The method of claim 13, wherein outputting the indication that the first input method is inappropriate as the active input method includes a second visual indicator on the text input device representing a third input method as a suggested second alternative.

16. The method of claim 1, further comprising:
storing first input information in a memory identifying the first set of discrete interactions associated with the first user input; and
generating a first order converted text from the first input information representing the first set of discrete interactions with the text input device being converted to replacement text using the second input method.

17. The method of claim 16, further comprising:
generating a second order converted text corresponding to a language translation of the first order converted text.

18. The method of claim 1, wherein determining whether there is the first orthographic incompatibility between the first input and at least one of the first input method and the second input method occurs in response to receiving a second input entered on the text input device.

19. A computing device, comprising:
a memory;
a display;
a text input device for receiving discrete interactions by a user of the computing device; and
a processor coupled to the memory, the display and the text input device, the processor configured with processor-executable instructions to perform operations comprising:
receiving a first input comprising a first set of discrete interactions by a user on the text input device as processed with a first input method active;
determining whether there is a first orthographic incompatibility between the first input and at least one of the first input method and a second input method; and
outputting an indication that the first input method is inappropriate as the active input method in response to the first input including the first orthographic incompatibility.

20. The computing device of claim 19, wherein the processor is configured with processor-executable instructions to perform operations such that determining whether there is a first orthographic incompatibility between the first input and at least one of the first input method and the second input method comprises determining whether the first set of discrete interactions match a first predefined set of discrete interactions convertible by the first input method into a first symbol.

21. The computing device of claim 20, wherein the processor is configured with processor-executable instructions to perform operations such that determining whether there is a first orthographic incompatibility between the first input and at least one of the first input method and the second input method further comprises determining whether the first set of discrete interactions match a second predefined set of discrete interactions convertible by the second input method into a second symbol.

22. The computing device of claim 21, wherein the processor is configured with processor-executable instructions to perform operations such that the second input method is selected based on a prior usage of the second input method in association with the text input device.

23. The computing device of claim 19, wherein the processor is configured with processor-executable instructions to perform operations such that determining whether there is a first orthographic incompatibility between the first input and at least one of the first input method and the second input method comprises determining whether a first entered text formed from the first user input includes a word not associated with the first input method.

24. The computing device of claim 19, wherein the processor is configured with processor-executable instructions to perform operations such that individual interactions of the first set of discrete interactions are entered into the text input device by way of at least one of a mouse movement, a finger swipe, a keystroke, a hold-time of the keystroke and a delay-time between the individual interactions.

25. The computing device of claim 19, wherein the processor is configured with processor-executable instructions to perform operations further comprising:
determining an error probability that the first user input includes the first orthographic incompatibility,
wherein the processor is configured with processor-executable instructions to perform operations such that outputting the indication that the first input method is inappropriate as the active input method occurs in response to the error probability exceeding a predefined threshold.

26. The computing device of claim 25, wherein the processor is configured with processor-executable instructions to perform operations such that the predefined threshold is adjustable based on a second input to the text input device.

27. The computing device of claim 25, wherein the processor is configured with processor-executable instructions to perform operations such that outputting the indication that the first input method is inappropriate as the active input method comprises converting the first set of discrete interactions to second entered text applying the second input method in response to the error probability exceeding the predefined threshold.

28. The computing device of claim 19, wherein the processor is configured with processor-executable instructions to perform operations such that determining whether there is the first orthographic incompatibility between the first input and at least one of the first input method and the second input method excludes a predefined set of discrete interactions from determining the first input includes the first orthographic incompatibility.

29. The computing device of claim 19, wherein the processor is configured with processor-executable instructions to perform operations such that determining whether there is a first orthographic incompatibility between the first input and at least one of the first input method and the second input method comprises determining whether the first set of discrete interactions match a second predefined set of discrete interactions convertible by the second input method into a second symbol in response to a program operating through the text input device requiring entered text match a language associated with the second input method.

30. The computing device of claim 19, wherein the processor is configured with processor-executable instructions to perform operations such that outputting the indication that the first input method is inappropriate as the active input method includes at least one of an audible sound, a vibration and a visible message presented on the display.

31. The computing device of claim 19, wherein the processor is configured with processor-executable instructions to perform operations such that outputting the indication that the first input method is inappropriate as the active input method includes a first visual indicator on the display representing the second input method as a suggested first alternative.

32. The computing device of claim 31, further comprising:
determining whether there is a second orthographical incompatibility between the first input and a third input method different from the first input method and the second input method, the third input method being excluded from the first visual indicator as a further suggested alternative.

33. The computing device of claim 31, wherein the processor is configured with processor-executable instructions to perform operations such that outputting the indication that the first input method is inappropriate as the active input method includes a second visual indicator on the display representing a third input method as a suggested second alternative.

34. The computing device of claim 19, wherein the processor is configured with processor-executable instructions to perform operations further comprising:
storing first input information in the memory identifying the first set of discrete interactions associated with the first user input; and
generating a first order converted text from the first input information representing the first set of discrete interactions with the text input device being converted to replacement text using the second input method.

35. The computing device of claim 34, wherein the processor is configured with processor-executable instructions to perform operations further comprising:
generating a second order converted text corresponding to a language translation of the first order converted text.

36. The computing device of claim 19, wherein the processor is configured with processor-executable instructions to perform operations such that determining whether there is a first orthographic incompatibility between the first input and at least one of the first input method and the second input method occurs in response to receiving a second input entered on the text input device.

37. A computing device configured to handle an inappropriate use by a user of a first input method adapted to convert discrete interactions by the user with a text input device to text symbols through an active input method selected from the first input method and a second input method, wherein at least one of the first and second input methods provides a conversion of a first set of discrete interactions to a symbol associated with a character set not shown on the text input device, the computing device comprising:
means for receiving a first input comprising the first set of discrete interactions by the user on the text input device as processed with the first input method active;
means for determining whether there is a first orthographic incompatibility between the first input and at least one of the first input method and the second input method; and
means for outputting an indication that the first input method is inappropriate as the active input method in response to the first input including the first orthographic incompatibility.

38. The computing device of claim 37, wherein means for determining whether there is a first orthographic incompatibility between the first input and at least one of the first input method and the second input method comprises means for determining whether the first set of discrete interactions match a first predefined set of discrete interactions convertible by the first input method into a first symbol.

39. The computing device of claim 38, wherein means for determining whether there is a first orthographic incompatibility between the first input and at least one of the first input method and the second input method further comprises means for determining whether the first set of discrete interactions match a second predefined set of discrete interactions convertible by the second input method into a second symbol.

40. The computing device of claim 39, wherein the second input method is selected based on a prior usage of the second input method in association with the text input device.

41. The computing device of claim 37, wherein means for determining whether there is a first orthographic incompatibility between the first input and at least one of the first input method and the second input method comprises means for determining whether a first entered text formed from the first user input includes a word not associated with the first input method.

42. The computing device of claim 37, wherein individual interactions of the first set of discrete interactions are entered into the text input device by way of at least one of a mouse movement, a finger swipe, a keystroke, a hold-time of the keystroke and a delay-time between the individual interactions.

43. The computing device of claim 37, further comprising:
means for determining an error probability that the first user input includes the first orthographic incompatibility,
wherein means for outputting the indication that the first input method is inappropriate as the active input method comprises means for outputting the indication that the first input method is inappropriate as the active input method in response to the error probability exceeding a predefined threshold.

44. The computing device of claim 43, wherein the predefined threshold is adjustable based on a second input to the text input device.

45. the computing device of claim 43, wherein means for outputting the indication that the first input method is inappropriate as the active input method comprises means for converting the first set of discrete interactions to second entered text applying the second input method in response to the error probability exceeding the predefined threshold.

46. The computing device of claim 37, wherein means for determining whether there is a first orthographic incompatibility between the first input and at least one of the first input method and the second input method excludes a predefined set of discrete interactions from determining the first input includes the first orthographic incompatibility.

47. The computing device of claim 37, wherein means for determining whether there is a first orthographic incompatibility between the first input and at least one of the first input method and the second input method comprises means for determining whether the first set of discrete interactions match a second predefined set of discrete interactions convertible by the second input method into a second symbol in response to a program operating through the text input device requiring entered text match a language associated with the second input method.

48. The computing device of claim 37, wherein means for outputting the indication that the first input method is inappropriate as the active input method comprises means for outputting at least one of an audible sound, a vibration and a visible signal.

49. The computing device of claim 37, wherein means for outputting the indication that the first input method is inappropriate as the active input method comprises means for displaying a first visual indicator on the text input device representing the second input method as a suggested first alternative.

50. The computing device of claim 49, further comprising:
means for determining whether there is a second orthographical incompatibility between the first input and a third input method different from the first input method and the second input method, the third input method being excluded from the first visual indicator as a further suggested alternative.

51. The computing device of claim 49, wherein means for outputting the indication that the first input method is inappropriate as the active input method comprises means for displaying a second visual indicator on the text input device representing a third input method as a suggested second alternative.

52. The computing device of claim 37, further comprising:
means for storing first input information in a memory identifying the first set of discrete interactions associated with the first user input; and
means for generating a first order converted text from the first input information representing the first set of discrete interactions with the text input device being converted to replacement text using the second input method.

53. The computing device of claim 52, further comprising:
means for generating a second order converted text corresponding to a language translation of the first order converted text.

54. The computing device of claim 37, wherein means for determining whether there is a first orthographic incompatibility between the first input and at least one of the first input method and the second input method comprises means for determining whether there is a first orthographic incompatibility between the first input and at least one of the first input method and the second input method in response to receiving a second input entered on the text input device.

55. A non-transitory computer readable storage medium having stored thereon processor-executable software instructions configured to cause a processor of a computing device to perform operations for handling an inappropriate use of a first input method by a user on a text input device adapted to convert discrete interactions by the user with the text input device to text symbols through an active input method selected from the first input method and a second input method, wherein at least one of the first and second input methods provides a conversion of a first set of discrete interactions to a symbol associated with a character set not shown on the text input device, the operations comprising:
receiving a first input comprising the first set of discrete interactions by the user on the text input device as processed with the first input method active;
determining whether there is a first orthographic incompatibility between the first input and at least one of the first input method and the second input method; and
outputting an indication that the first input method is inappropriate as the active input method in response to the first input including the first orthographic incompatibility.

56. The non-transitory computer readable storage medium of claim 55, wherein the stored processor-executable instructions are configured to cause the processor of a computing device to perform operations such that determining whether there is the first orthographic incompatibility between the first input and at least one of the first input method and the second input method comprises determining whether the first set of discrete interactions match a first predefined set of discrete interactions convertible by the first input method into a first symbol.

57. The non-transitory computer readable storage medium of claim 56, wherein the stored processor-executable instructions are configured to cause the processor of the computing device to perform operations such that determining whether there is a first orthographic incompatibility between the first input and at least one of the first input method and the second input method further comprises determining whether the first set of discrete interactions match a second predefined set of discrete interactions convertible by the second input method into a second symbol.

58. The non-transitory computer readable storage medium of claim 57, wherein the stored processor-executable instructions are configured to cause the processor of the computing device to perform operations such that the second input method is selected based on a prior usage of the second input method in association with the text input device.

59. The non-transitory computer readable storage medium of claim 55, wherein the stored processor-executable instructions are configured to cause the processor of the computing device to perform operations such that determining whether there is a first orthographic incompatibility between the first input and at least one of the first input method and the second input method comprises determining whether a first entered text formed from the first user input includes a word not associated with the first input method.

60. The non-transitory computer readable storage medium of claim 55, wherein the stored processor-executable instructions are configured to cause the processor of the computing device to perform operations such that individual interactions of the first set of discrete interactions are entered into the text input device by way of at least one of a mouse movement, a finger swipe, a keystroke, a hold-time of the keystroke and a delay-time between the individual interactions.

61. The non-transitory computer readable storage medium of claim 55, wherein the stored processor-executable instructions are configured to cause the processor of the computing device to perform operations further comprising:
determining an error probability that the first user input includes the first orthographic incompatibility,
wherein the stored processor-executable instructions are configured to cause the processor of the computing device to perform operations such that outputting the indication that the first input method is inappropriate as the active input method occurs in response to the error probability exceeding a predefined threshold.

62. The non-transitory computer readable storage medium of claim 61, wherein the stored processor-executable instructions are configured to cause the processor of the computing device to perform operations such that the predefined threshold is adjustable based on a second input to the text input device.

63. The non-transitory computer readable storage medium of claim 61, wherein the stored processor-executable instructions are configured to cause the processor of the computing device to perform operations such that outputting the indication that the first input method is inappropriate as the active input method comprises converting the first set of discrete interactions to second entered text applying the second input method in response to the error probability exceeding the predefined threshold.

64. The non-transitory computer readable storage medium of claim 55, wherein the stored processor-executable instructions are configured to cause the processor of the computing device to perform operations such that determining whether there is a first orthographic incompatibility between the first input and at least one of the first input method and the second input method excludes a predefined set of discrete interactions from determining the first input includes the first orthographic incompatibility.

65. The non-transitory computer readable storage medium of claim 55, wherein the stored processor-executable instructions are configured to cause the processor of the computing device to perform operations such that determining whether there is a first orthographic incompatibility between the first input and at least one of the first input method and the second input method comprises determining whether the first set of discrete interactions match a second predefined set of discrete interactions convertible by the second input method into a second symbol in response to a program operating through the text input device requiring entered text match a language associated with the second input method.

66. The non-transitory computer readable storage medium of claim 55, wherein the stored processor-executable instructions are configured to cause the processor of the computing device to perform operations such that outputting the indication that the first input method is inappropriate as the active input method includes at least one of an audible sound, a vibration and a visible signal reflecting the indication that the first input method is inappropriate as the active input method.

67. The non-transitory computer readable storage medium of claim 55, wherein the stored processor-executable instructions are configured to cause the processor of the computing device to perform operations such that outputting the indication that the first input method is inappropriate as the active input method includes a first visual indicator on the text input device representing the second input method as a suggested first alternative.

68. The non-transitory computer readable storage medium of claim 67, wherein the stored processor-executable instructions are configured to cause the processor of the computing device to perform operations further comprising:
determining whether there is a second orthographical incompatibility between the first input and a third input method different from the first input method and the second input method, the third input method being excluded from the first visual indicator as a further suggested alternative.

69. The non-transitory computer readable storage medium of claim 67, wherein the stored processor-executable instructions are configured to cause the processor of the computing device to perform operations such that outputting the indication that the first input method is inappropriate as the active input method includes a second visual indicator on the text input device representing a third input method as a suggested second alternative.

70. The non-transitory computer readable storage medium of claim 55, wherein the stored processor-executable instructions are configured to cause the processor of the computing device to perform operations further comprising:
storing first input information in a memory identifying the first set of discrete interactions associated with the first user input; and
generating a first order converted text from the first input information representing the first set of discrete interactions with the text input device being converted to replacement text using the second input method.

71. The non-transitory computer readable storage medium of claim 70, wherein the stored processor-executable instructions are configured to cause the processor of the computing device to perform operations further comprising:
generating a second order converted text corresponding to a language translation of the first order converted text.

72. The non-transitory computer readable storage medium of claim 55, wherein the stored processor-executable instructions are configured to cause the processor of the computing device to perform operations such that determining whether there is the first orthographic incompatibility between the first input and at least one of the first input method and the second input method occurs in response to receiving a second input entered on the text input device.
